(19) United States
(12) Patent Application Publication
(10) Pub. No.: US 2016/0062502 A1
(43) Pub. Date: Mar. 3, 2016

(54) TOUCH DISPLAY DEVICE, DRIVING METHOD THEREOF AND MANUFACTURING METHOD THEREOF

(71) Applicant: MStar Semiconductor, Inc., Hsinchu County (TW)

(72) Inventors: Chi Kang Liu, Hsinchu County (TW); Ping-Yu Chan, Hsinchu County (TW); Guo-Kiang Hong, Hsinchu County (TW)

(21) Appl. No.: 14/635,290

(22) Filed: Mar. 2, 2015

Related U.S. Application Data
(60) Provisional application No. 62/043,430, filed on Aug. 29, 2014.

(30) Foreign Application Priority Data
Dec. 5, 2014 (TW) 103142447

(51) Int. Cl. G06F 3/044

(52) U.S. Cl. CPC G06F 3/044; G06F 2203/04103

(57) ABSTRACT

A touch display device includes a substrate, a conductive layer and a transparent layer. The conductive layer is disposed on the substrate layer, and includes a plurality of metal lines, which extend along a first direction and are insulated from one another. The transparent layer is disposed on the conductive layer, and includes a plurality of first electrode strips, which extend along the first direction and individually overlap with at least one of the metal lines in a second direction substantially perpendicular to the substrate. The first electrode strips are disposed between a plurality of second electrode strips and the metal lines. The second electrode strips extend along a third direction different from the first direction and are disposed above the transparent layer. The second electrode strips form capacitance coupling with the metal lines via the first electrode strips to perform touch sensing.

This application claims the benefit of U.S. Provisional Application Ser. No. 62/043,430, filed Aug. 29, 2014, and Taiwan Application Serial No. 103142447, filed Dec. 5, 2014, the subject matter of which is incorporated herein by reference.

### BACKGROUND OF THE INVENTION

1. Field of the Invention

The invention relates in general to a touch display device, a driving method thereof and a manufacturing method thereof, and more particularly, to a touch display device that utilizes a conductive layer of a display panel and a transparent layer on the display panel as touch sensing devices, a driving method and a manufacturing method thereof.

2. Description of the Related Art

A conventional touch display device is formed by directly adhering a touch panel to a display panel by an optical adhesive. Thus, the overall thickness and the weight of the panel are greater than those of one single display panel, adding to a load in user portability. In a current touch panel integrated with a touch function, a newly added touch sensing circuit utilizes transparent electrode blocks that are not connected to one another as driving electrodes and sensing electrodes. Indium tin oxide (ITO), having moderate electric conductivity, is generally adopted for transparent electrodes. Therefore, not only the value of received touch sensing signals is affected but also the sensitivity of touch sensing devices is limited.

### SUMMARY OF THE INVENTION

The primary object of the present invention is to provide a touch display device that simultaneously reduces the thickness and the weight of a display panel integrated with a touch function without degrading functions of the display panel.

To achieve the above object, the present invention provides a touch display device. The touch display device includes a first substrate, a conductive layer and a first transparent layer. The conductive layer is disposed on the first substrate, and includes a plurality of metal lines. The metal lines extend along a first direction, and are insulated from one another. The first transparent layer is disposed on the conductive layer, and includes a plurality of first electrode strips. The first electrode strips extend along the first direction, and individually overlap with at least one of the metal lines in a second direction substantially perpendicular to the substrate. The first electrode strips are disposed between a plurality of second electrode strips and the metal lines. The second electrode strips extend along a third direction different from the first direction, and are disposed above the first transparent layer. The second electrode strips form capacitance coupling with the metal lines via the first electrode strips to perform touch sensing.

To achieve the above object, the present invention further provides a driving method of a touch display device. The touch display device includes a plurality of metal lines, a plurality of first electrode strips and a plurality of second electrode strips. The metal lines and the first electrode strips extend along a first direction, the first electrode strips individually overlap with at least one of the metal lines in a second direction of the display device substantially perpendicular to the substrate, and the second electrode strips extend along a third direction different from the first direction. In a display period, a display signal is transmitted to at least one of the metal lines, and a common voltage signal is transmitted to at least one of the first electrode strips. In a touch control period, a touch driving signal is transmitted to at least one of metal lines, at least one of the first electrode strips correspond to the at least one of the metal lines is kept floating, and a sensing signal is received from the second electrode strip corresponding to the at least one of the metal lines.

To achieve the above object, a manufacturing method of a touch display device is provided. A first substrate is provided. A conductive layer is formed on the first substrate. The conductive layer includes a plurality of metal lines, which extend along a first direction and are insulated from one another. A first transparent layer is formed on the conductive layer. The first transparent layer includes a plurality of first electrode strips. The first electrode strips extend along the first directly, and individually overlap with at least one of the metal lines in a second direction substantially perpendicular to the first substrate. A plurality of second electrode strips are formed on the first transparent layer. The second electrode strips extend along a third direction different from the first direction, and form capacitance coupling with the metal lines via the first electrode strips to perform touch sensing.

In the touch display device of the present invention, the metal lines may be utilized to transmit touch display signals including touch driving signal and pixel voltage signals or pixel switch signals. Therefore, in addition to serving as conducting lines that the display panel uses for transmitting pixel voltage signals or pixel switch signals, the metal lines can also form touch sensing devices with the second electrode strips. As such, a touch electrode layer for transmitting touch signals can be omitted in the touch display device of the present invention, thereby effectively reducing the thickness and the manufacturing costs of the touch display device. Further, in the present invention, with the first electrode strips disposed between the metal lines and the second electrode strips, coupling capacitance between the metal lines and the second electrode strips can be increased, and the touch sensitivity of the touch sensing devices can also be enhanced.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a top view of a touch display device according to a first embodiment of the present invention;

FIG. 2 is a section view along a section line A-A′ in FIG. 1;

FIG. 3 is a flowchart of a driving method of a touch display device according to the first embodiment of the present invention;

FIG. 4 is a timing diagram of a pixel switch signal transmitted by a gate line, a touch display signal transmitted by a data line, a signal transmitted by a first electrode strip and a sensing signal sensed by a second electrode strip of the present invention;

FIG. 5 is a flowchart of a manufacturing method of a touch display device according to the first embodiment of the present invention;

FIG. 6 is a schematic diagram of a step for forming an array substrate according to the first embodiment of the present invention;

FIG. 7 is a schematic diagram of a step for forming a color filter substrate and a second electrode strip according to the first embodiment of the present invention;

FIG. 8 is a top view of a touch display device according to a second embodiment of the present invention;

FIG. 9 is a flowchart of a driving method of a touch display device according to the second embodiment of the present invention;

FIG. 10 is a timing diagram of a touch display signal transmitted by a gate line, a pixel voltage signal transmitted by a data line, a signal transmitted by a first electrode strip and a sensing signal sensed by a second electrode strip of the present invention;

FIG. 11 is a section view of a touch display device according to a third embodiment of the present invention;

FIG. 12 is a section view of a touch display device according to a fourth embodiment of the present invention;

FIG. 13 is a top view of a touch display device according to a fifth embodiment of the present invention;

FIG. 14 is a section view of a touch display device according to a sixth embodiment of the present invention; and

FIG. 15 is a section view of a touch display device according to a seventh embodiment of the present invention.

### DETAILED DESCRIPTION OF THE INVENTION

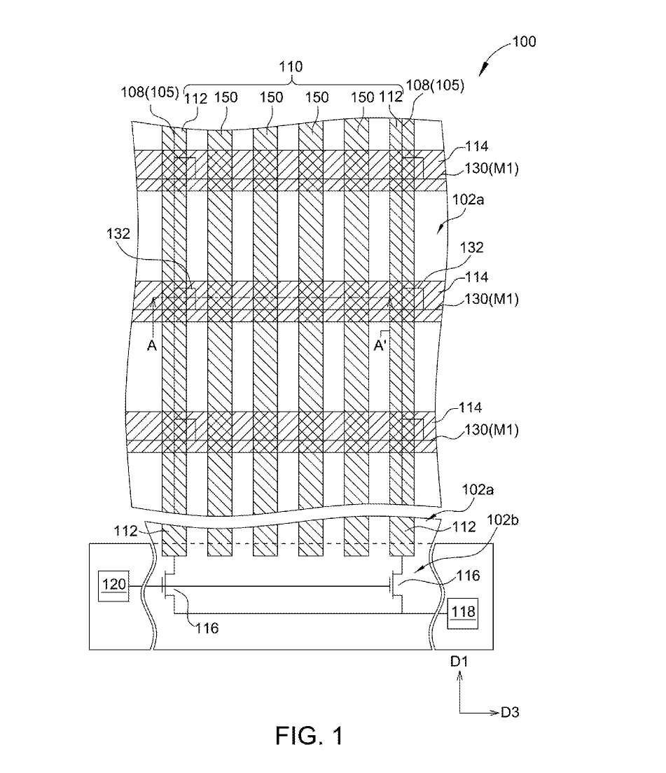

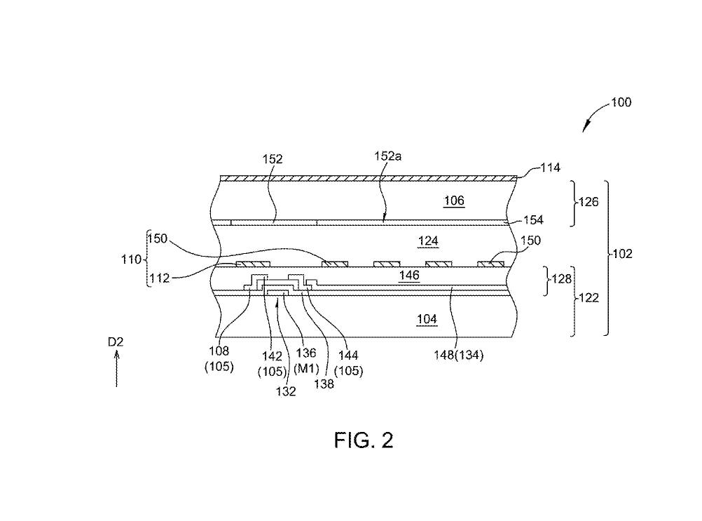

Referring to FIG. 1 and FIG. 2, according to a first embodiment of the present invention, a touch display device 100 includes a display panel 102. The display panel 102 has an active region 102a and a border region 102b, and includes a first substrate 104, a conductive layer 105 and a first transparent layer 110. The conductive layer 105 is disposed on the first substrate 104, and includes a plurality of metal lines 108. The metal lines 108 are disposed in the active region 102a, extend along a first direction D1, and are insulated from one another. The first transparent layer 110 is disposed on the conductive layer 105, and includes a plurality of first electrode strips 112. The first electrode strips 112 are disposed in the active region 102a, extend along the first direction D1, and individually overlap with at least one of the metal lines 108 in a second direction D2 substantially perpendicular to the first substrate 104, such that the first electrode strips 112 couple with at least one of the metal lines 108. In the embodiment, for example, the first electrode strips 112 respectively cover the metal wires 108.

The touch display device 100 may further includes a plurality of second electrode strips 114, which extend along a third direction D3 different from the first direction D1. The first electrode strips 112 are disposed between the second electrode strips 114 and the metal lines 108. The metal lines 108 disposed along the first direction D1 may couple with the second electrode strips 114 disposed along the third direction D3 via the first electrode strips 112 to form touch sensing devices. In the embodiment, the touch display device 100 may further include a second substrate 106 that is disposed opposite the first substrate 104. Further the second electrode strips 114 are disposed on an outer surface of the second substrate 106.

The touch display device 100 may selectively further include a plurality of switches 116 disposed on an inner surface of the first substrate 104 in the border region 102b and facing the second substrate 106. Each of the switches 116 has one end electrically connected to one of the electrode strips 112, and the other end electrically connected to the same signal pad 118 to provide a common voltage. More specifically, each of the switches 116 may be a first thin film transistor. The first thin film transistors have their drains respectively electrically connected the first electrode strips 112, their gates electrically connected to a control pad 120 to control the turning on/off of the first thin film transistors, and their sources electrically connected to the signal pad 118.

It should be noted that, when the touch display device performs a touch function, the control pad 120 does not provide a voltage signal to the gates of the first thin film transistors corresponding to the touch function, in a way that the first thin film transistors are in a turn-off state, and the first electrode strips 112 electrically connected to the first thin film transistors 112 are in a floating state. Accordingly, the first electrode strips 112 are insulated from one another, and are allowed to respectively couple with the metal lines 108 to further change the voltages of the first electrode strips 112 with the signals of the metal lines 108. Further, the first electrode strips 112 may also couple with the second electrode strips 114, such that the second electrode strips 114 may form capacitance coupling with the metal lines 108 via the first electrode strips 112 to achieve touch sensing. When the touch display device 100 performs the display function, the control pad 120 provides a turn on voltage to the gates of the first thin film transistors to turn on the first thin film transistors. Thus, the common voltage provided by the signal pad 118 is provided to all of the first electrode strips 112 via the first thin film transistors to have the first electrode strips 112 serve as common electrodes.

In the embodiment, the display panel 102 may be a liquid crystal display (LCD) panel. For example, the display panel 102 is formed by an array substrate 122, the first transparent layer 110, a liquid crystal layer 124 and a color filter substrate 126. The display panel 102 may also be other types of array display panels, e.g., an organic light-emitting diode (OLED) display panel. The array substrate 122 and the color filter substrate 126 are disposed opposite each other, with the liquid crystal layer 124 disposed between the array substrate 122 and the color filter substrate 126. The array substrate 122 may include the first substrate 104 and a pixel element layer 128. The pixel element layer 128 may include the conductive layer 105, and the conductive layer 105 may be formed by any conductive layer in the pixel element layer 128. In the embodiment, the metal lines 108 may serve as data lines of the pixel element layer 128. In the above situation, for example, the first direction D1 may be the vertical direction, and the third direction D3 may be the horizontal direction. In addition to the metal lines 108, the pixel element layer 128 may further include a plurality of gate lines 130, a plurality of second thin film transistors 132 and a second transparent layer 134. The gate lines 130 transmit pixel switch signals to turn on/off the corresponding second thin film transistors 132, and are staggered with and insulated from the metal lines 108. The second thin film transistors 132 are in an array arrangement, and are correspondingly disposed at intersections of the gate lines 130 and the metal lines 108. Each of the second thin film transistors 132 may include a gate 136, a gate insulation layer 138, a source 142 and a drain 144. Each of the gates 136 is connected to one corresponding gate line 130. That is, the gates 136 of the second thin film transistors 132 of the same row are electrically connected to the same gate line 130. In the embodiment, the gates 136 and the gate lines 130 are formed by a first metal pattern layer M1. The gate insulation layer 138 covers inner surfaces of the first metal pattern layer M1 and the first substrate 104. The sources 142 and the drains 144 are disposed on the gate insulation layer 138, and are disposed correspondingly at two sides of the gates 136. Further, the sources 142 are electrically connected to one of the metal lines 108. That is, the sources 142 of the second thin film transistors 132 of the same row are electrically connected to the same metal line 108. In the embodiment, the sources 142, the drains 144 and the metal lines 108 may be formed by the conductive layer 105. For example, the conductive layer 104 may be the second metal pattern layer, or be formed by another conductive material. Instead of the exemplary type above, the second thin film transistors 132 of the present invention may be another type, e.g., top gate thin film transistors.

The pixel element 128 further includes an insulation layer 146. The insulation layer 146 is disposed between the first transparent layer 110 and the second transparent layer 134, and electrically insulates the first transparent layer 110 and the second transparent layer 134. The first transparent layer 110 and the second transparent layer 134 may be formed by a transparent conductive material, e.g., ITO or indium zinc oxide (IZO). In the embodiment, the second transparent layer 134 may include a plurality of pixel electrodes 148, which are respectively electrically connected to the drains 144 of the second thin film transistors 132. The first transparent layer 110 may further include a plurality of third electrode strips 150 as common electrodes. At least every two of the third electrode strips 150 are disposed between any two adjacent first electrode strips 112, and are located right above the pixel electrodes 148. As a gap is present between any two adjacent third electrodes 150, when a frame is displayed, an electric field formed by the pixel voltages of the pixel electrodes 148 may penetrate through the gap to form a lateral (horizontal) electric field with the common voltages of the third electrode strips 150 to drive liquid crystal particles of the liquid crystal layer 124. In another embodiment, the touch display device 100 may further include a plurality of switches. These switches switch the third electrode strips to a floating state when the touch display device 100 performs a touch function, and switch the third electrode strips to connect to a common voltage when the touch display device 100 performs a display function. These switches may be formed by a third film transistor.

The color filter substrate 126 may include the second substrate 106, a black pattern layer 152 and a plurality of color filter plates 154. The liquid crystal layer 124 is disposed between the first substrate 104 and the second substrate 106. The black pattern layer 152 and the color filter plates 154 are disposed between the liquid crystal layer 124 and the second substrate 106. The black pattern layer 152 includes a black matrix, and shields the second thin film transistors 132, the metal lines 108 and the gate lines 130 formed by the first metal pattern layer M1 and the conductive layer 105. Further, the black pattern layer 152 has a plurality of openings 152a disposed correspondingly to the pixel electrodes 148, respectively. The color filter plates 154 are disposed on the second substrate 106 of the openings 152a.

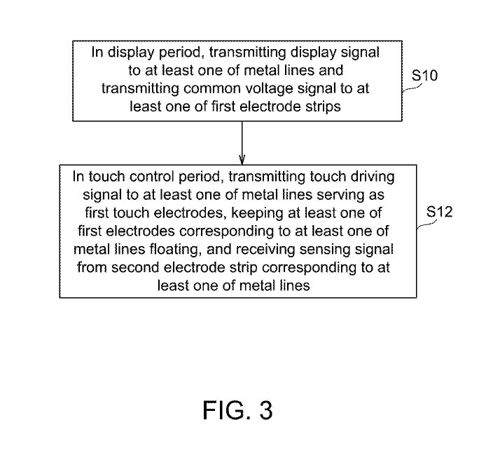

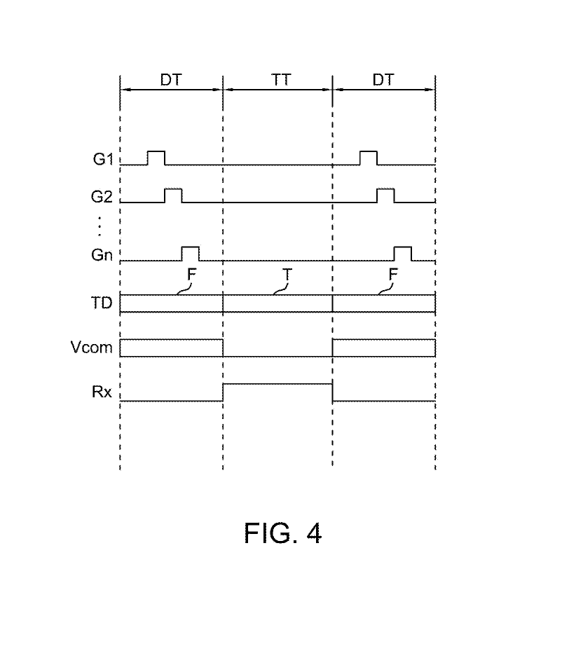

Details of a driving method of the touch display device 100 are given below. The driving method simultaneously provides functions of image display and touch sensing. Referring to FIG. 3 and FIG. 4 as well as FIG. 1 and FIG. 2, a driving period of the touch display device 100 according to the embodiment includes a display period DT and a touch control period TT. The display period DT and the touch control period TT are non-overlapping. The driving method of the touch display device 100 includes following steps.

In step S10, in the display period DT, a display signal F is transmitted to at least one of the metal lines 108, and a common voltage signal Vcom is transmitted to at least one of the first electrode strips 112.

In step S12, in the touch control period TT, a touch driving signal T is transmitted to at least one of the metal lines 108 serving as first touch electrodes, at least one of the first electrode strips 112 corresponding to the at least one of the metal lines 108 is kept floating, and a sensing signal Rx is received from at least one of the second electrode strips 114 serving as second touch electrodes and corresponding to the metal line 108.

In the display period DT in step S10, as the metal lines 108 of the embodiment are data lines, the display signal F is a pixel voltage signal. That is, in the display period DT, the pixel voltage signal is transmitted to at least one of the metal lines 108, and pixel switch signals G1 to Gn are transmitted to at least one of the gate lines 130 to turn on the corresponding second thin film transistor 132 such that the pixel electrode 148 corresponding to the second thin film transistor 132 is allowed to have the corresponding pixel voltage. Meanwhile, the common voltage signal Vcom transmitted to the first electrode strips 112 is also transmitted to the third electrode strips 150, and has the common voltage in the display period DT. Thus, a lateral electric field is formed between the pixel electrodes 148 and the first electrode strips 112 as well as the third electrode strips 150 to enable the touch display device 100 to display a frame. More specifically, the common voltage signal Vcom transmitted to the first electrode strips 112 is provided by the signal pad 118 to be transmitted to the first electrode strips 112 via the switches 116.

In the touch control period TT in step S12, the pixel switch signals G1 to Gn are no longer transmitted to the gate lines 130 to turn off the corresponding second thin film transistor 132. At this point, the signal transmitted to at least one of the metal lines 108 is changed to the touch driving signal T, and the step of keeping the first electrode strip 112 corresponding to the at least one of the metal lines 108 floating includes turning off the switches 116 to stop transmitting the common voltage signal Vcom to the first electrode strips 112, such that at least one of the first electrode strips 112 is kept in a floating state. Further, the touch driving signal T may be simultaneously or sequentially transmitted to different metal lines 108, and the first electrode strip 112 corresponding to the metal line 108 that transmits the touch driving signal T, i.e., the first electrode strip 112 that overlaps the metal line 108 and/or the adjacent first electrode strip 112, is also in a floating state, thereby preventing the first electrode strip(s) 112 from affecting the displayed frame. The first electrode strips 112 may be coupled to the corresponding metal lines 108, and generate signals along with the change in the touch driving signal T. Meanwhile, according to the sensing signal Rx sensed by the second electrode strips 114, it may be determined whether the touch display device 100 is touched or approached by an object, and a position of the object may then be detected. In another embodiment, the third electrode strips 150 may also be kept floating in the touch control period TT.

In the embodiment, the display period DT is the time that the display panel 102 uses to display one frame, and so the touch display device 100 may transmit the touch driving signal T to the metal lines 108 and receive the sensing signal between different display periods DT in which different frames are displayed. In another embodiment, the touch control period TT may be an interval between periods of any two adjacent pixel switches signals G1 to Gn. That is, the display period DT may be divided into two periods, which may respectively correspond to different pixel switch signals G1 to Gn of a same frame. Further, the touch control period TT is also located therein to prevent the touch driving signal T from interfering with the displayed frame.

It should be noted that, the touch driving signals T and the pixel voltage signals F of the embodiment may be integrated into one touch display signal TD, which is the pixel voltage signal F in the display period DT and the touch driving signal T in the touch control period TT. Accordingly, the metal lines 108 serving as data lines may transmit the pixel voltage signals F in the display period DT to serve as conducting wires for transmitting the pixel voltage signal F of a displayed frame, and transmit the touch driving signal T in the touch control period TT to serve as driving electrodes that touch sensing devices use to transmit the touch driving signal T. Therefore, the touch electrode layer for transmitting the touch driving signal T can be omitted in the touch display device 100 of the embodiment, thereby effectively reducing the thickness as well as manufacturing costs of the touch display device 100. Further, in the touch display device 100 of the present invention, the first electrode strips 112 are disposed between the metal lines 108 and the second electrode strips 114 to enhance the touch sensitivity of the touch sensing devices.

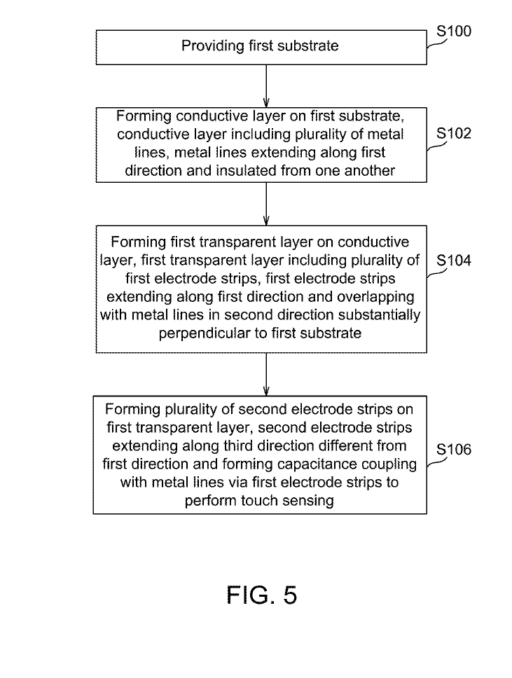

The present invention further provides a manufacturing of the touch display device 100. Referring to FIG. 5, the manufacturing method of the touch display device 100 of the embodiment includes following steps.

In step S100, the first substrate 104 is provided.

In step S102, the conductive layer 105 is formed on the first substrate 104. The conductive layer 105 includes a plurality of metal lines 108, which extend along the first direction D1 and are insulated from one another.

In step S104, the first transparent layer 110 is formed on the conductive layer 105. The first transparent layer 110 includes a plurality of first electrode strips 112. The first electrode strips 112 extend along the first direction D1, and individually overlap with the metal lines 108 in a second direction D2 substantially perpendicular to the first substrate 104.

In step S106, a plurality of second electrode strips 114 are formed on the first transparent layer 110. The second electrode strips 114 extend along the third direction D3 different from the first direction D1, and form capacitor coupling with the metal lines 108 via the first electrode strips 112 to perform touch sensing.

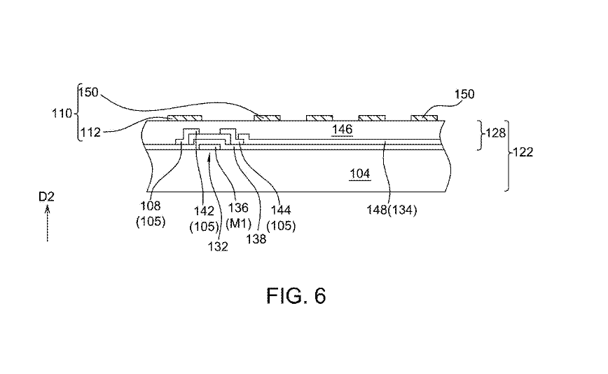

Referring to FIG. 6 as well as FIG. 5, as the metal lines 108 of the present invention are data lines, between step S102 and step S100, the manufacturing method of the present invention may further include forming the first metal pattern layer M1 on the first substrate 104 and covering the gate insulation layer 138 on the first metal pattern layer M1 and the first substrate 104. In step S102, the conductive layer 105 is formed on the gate insulation layer 138. Between step S102 and step S100, the manufacturing method of the embodiment may further include forming the second transparent layer 134 on the drains 144 of the conductive layer 105 and the gate insulation layer 138. The insulation layer 146 then covers the thin film transistors 132 and the second transparent layer 134. At this point, the pixel element layer 128 of the embodiment is formed. In step S104, the first transparent layer 110 is formed on the insulation layer 146.

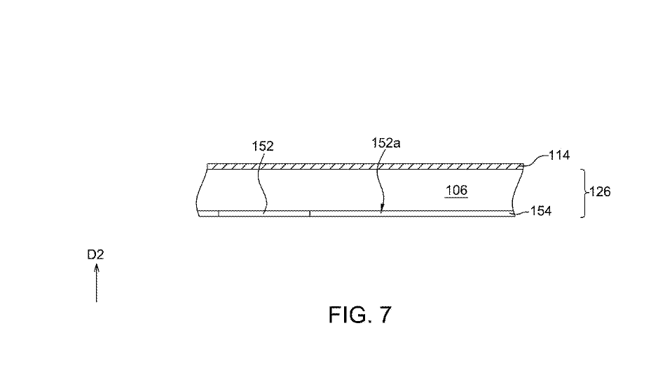

Referring to FIG. 7, before step S106, the manufacturing method of the embodiment firstly provides the second substrate 106, and then forms the second electrode strips 114 on the outer surface of the second substrate 106. It should be noted that the above details are not to be construed as a limitation to the present invention. Further, the manufacturing method of the present invention may further include forming the black pattern layer 152 and the color filter plates 154 on the inner surface of the second substrate 106. As this step does not affect the implementation of step S106, it can be performed before or after step S106. Further, the step of forming the second electrode strips 114, the black pattern layer 152 and the color filter plates 154 on the second substrate 106 does not affect the formation of the conductive layer 105 and the first transparent layer 110 on the first substrate 104, the steps performed on the second substrate 106 may be before or after the step of forming the conductive layer 105 and the first transparent layer 110.

Referring to FIG. 5, after completing the manufacturing steps of the elements on the first substrate 104 and the second substrate 106, the first substrate 104 and the second substrate 106 are disposed opposite and combined with each other, and the liquid crystal layer 124 is filled between the first substrate 104 and the second substrate 106. At this point, the touch display device 100 according to the embodiment of the present invention is formed. The first substrate 104 and the second substrate 106 may be combined to each other by a sealant.

It should be noted that, the touch display device of the present invention is not limited to be implemented as the foregoing embodiments. Other embodiments are to be described below. For the sake of simplicity and to emphasize the differences between the embodiments or the variations, the same elements are represented by the same denotations and associated details are omitted herein.

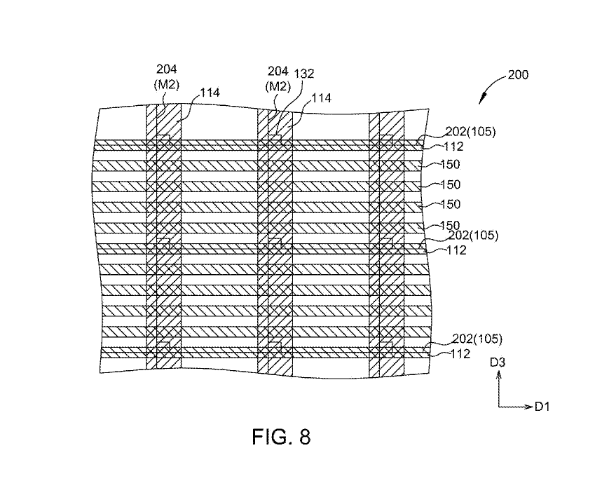

FIG. 8 shows a second embodiment of the present invention. Compared to the first embodiment, each of the metal lines 202 of a touch display device 200 of the embodiment is a gate line, and extends along the first direction D1. Thus, the conductive layer 105 is the first metal pattern layer. In the embodiment, the first direction D1 is the horizontal direction, and the third direction D3 is the vertical direction. The display panel further includes a plurality of data lines 204. The data lines 204 extend along the third direction D3, and are staggered with and insulated from the metal lines 202. The data lines 204 are formed by the second metal pattern layer M2. Further, the first electrode strips 112 extend along the extension direction of the metal lines 202 serving as gate lines, i.e., along the first direction D1, and individually overlap with at least one of the metal lines 202 in a second direction D2 substantially perpendicular to a plane formed by the first direction D1 and the second direction D3, such that the metal lines 202 are allowed to couple with the second electrode strips 114 via the first electrode strips 112, respectively. In the embodiment, for example, the first electrode strips 112 cover the metal lines 202, respectively.

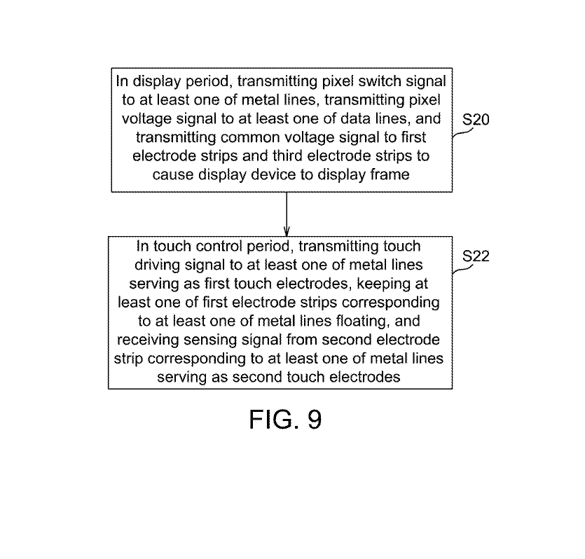

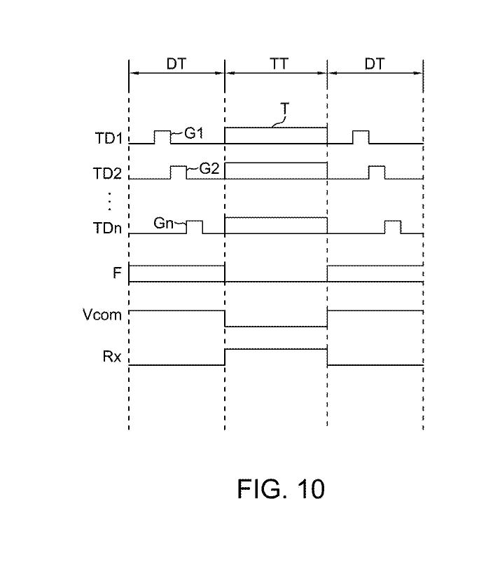

Details of a driving method of the touch display device 200 according to the embodiment of the present invention are given below. The driving method simultaneously supports functions of image display and touch sensing. Referring to FIG. 9 and FIG. 10, the driving method of the touch display device 200 according to the embodiment includes following steps.

In step S20, in the display period DT, pixel switch signals G1 to Gn are transmitted to at least one of the metal lines 202, a pixel voltage signal F is transmitted to at least one of the data lines, and a common voltage signal Vcom is transmitted to the first electrode strips 112 and the third electrode strips 150 to cause the touch display device 200 to display a frame.

In step S22, in the touch control period TT, a touch driving signal T is transmitted to the at least one of the metal lines 202 serving as the first touch electrodes, at least one of the first electrode strips 112 corresponding to the at least one of the metal lines 202 is kept floating, and a sensing signal Rx is received from at least one of the second electrode strips 114 corresponding to the metal line 202 and serving as second touch electrodes.

Compared to the first embodiment, as the metal lines 202 of the embodiment are gate lines, the display signal transmitted to the metal lines 202 is the pixel switch signals G1 to Gn. Further, the pixel voltage signal F is transmitted to the data lines 204. Therefore, in the driving method of the embodiment, the touch driving signals T and the pixel switch signals G1 to Gn are integrated into touch display signals TD1 to TDn, which are the pixel switch signals G1 to Gn in the display period DT and the touch driving signals T in the touch control period TT. Further, the touch display signals TD1 to TDn are transmitted via the metal lines 202. Accordingly, the metal lines 202 serving as gate lines may transmit the pixel switch signals G1 to Gn in the display period DT to serve as conducting lines of the pixel switch signals G1 to Gn of the second thin film transistors 132, and transmit the touch driving signals T in the touch control period TT to serve as driving electrodes that the touch sensing devices use to transmit the driving signals T. In the embodiment, the data lines 204 transmit the pixel voltage signals F in the display period DT, and do not transmit signals in the touch control period TT. Details of driving the first electrode strips 112, the second electrode strips 114 and the third electrode strips 150 are the same as those of the first embodiment, and shall be omitted herein.

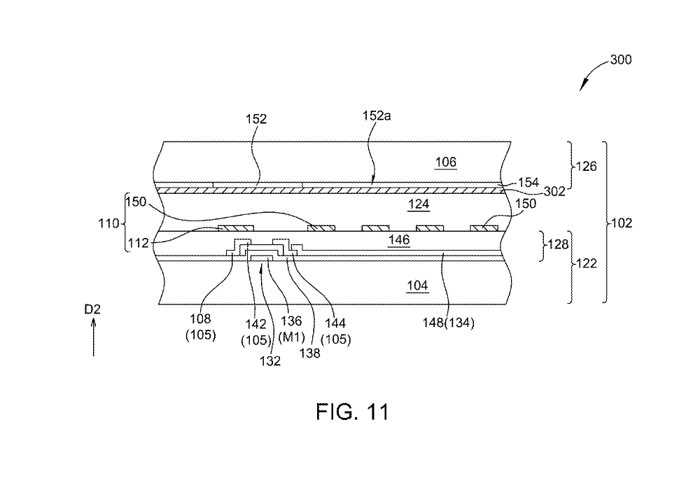

FIG. 11 shows a third embodiment of the present invention. Compared to the first embodiment, in a touch display device 300 of the embodiment, second electrode strips 302 are formed on the inner surface of the second substrate 106 before the first substrate 104 and the second substrate 106 are combined. More specifically, the second electrode strips 302 may be formed on the black pattern layer 152 and the color filter plates 154 after the step of forming the black pattern layer 152 and the color filter plates 154. Thus, after the first substrate 104 and the second substrate 106 are combined, the second electrode strips 302 may be disposed between the black pattern layer 152 and the liquid crystal layer 124 and between the color filter plates 154 and the liquid crystal layer 124. In another embodiment, the second electrode strips may also be formed on the second substrate 106 before the step of forming the black pattern layer 152 and the color filter plates 154, such that the second electrode strips may be located between the black pattern layer 152 and the second substrate 106 and between the color filter plates 154 and the second substrate 106.

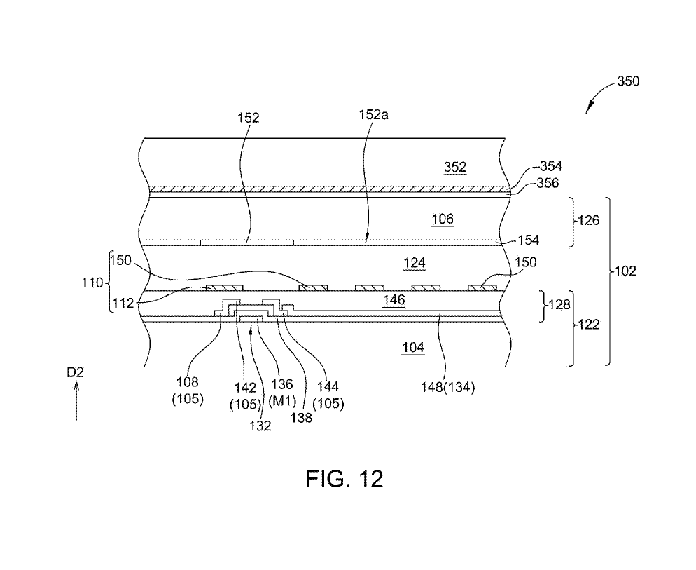

FIG. 12 shows a fourth embodiment of the present invention. Compared to the first embodiment, a touch display device 350 of the embodiment may further include a cover plate 352 disposed on the outer surface of the second substrate 106, and second electrode strips 354 may be disposed on the surface of the second substrate 106 facing the cover plate 352. Further, the cover plate 352 may be adhered on the outer surface of the second substrate 106 via an adhesive layer 356. One main difference of the manufacturing method of the touch display device 350 of the embodiment from the first embodiment is that, instead of forming the second electrode strips on the outer surface of the second substrate 106, the cover plate 352 is additionally provided and the second electrode strips 354 are formed on the cover plate 352. Next, one side of the cover plate 352 formed with the second electrode strips 354 is adhered to the outer surface of the second substrate 106 via the adhesive layer 356. In the embodiment, the step of adhering the cover plate 352 on the second substrate 106 may be performed before or after the step of combining the first substrate 104 and the second substrate 106.

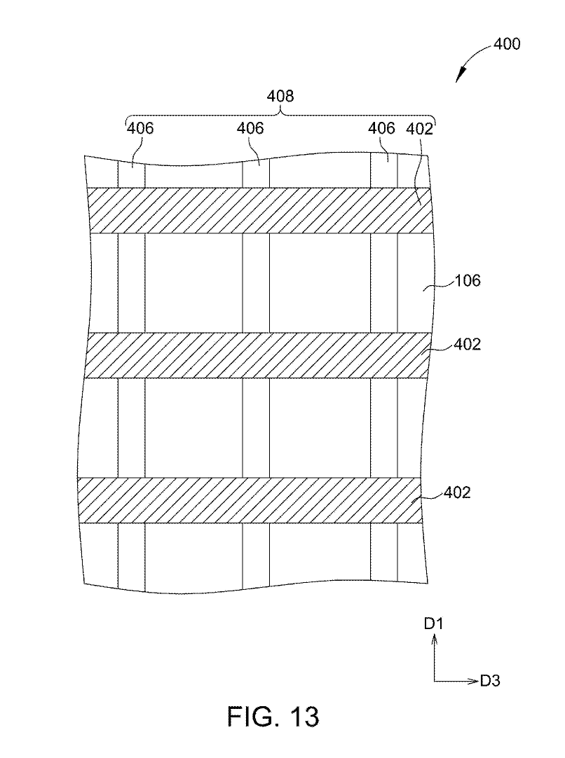

FIG. 13 shows a fifth embodiment of the present invention. Compared to the first embodiment, second electrode strips 402 of a touch display device 400 of the embodiment may be a part of a black matrix, and are formed by an opaque conductive material, e.g., at least one of a metal, a metal lattice, nano silver particles and graphite. That is, the touch display device 400 may include a black pattern layer 408. The black pattern layer 408 includes a black matrix formed by the second electrode strips 402 and black shielding strips 406, and is disposed on the inner surface of the second substrate 106. As such, the second electrode strips 402 are disposed in the black pattern layer 408. One main difference of the manufacturing method of the touch display device 400 of the embodiment from the first embodiment is that, in the manufacturing method according to the embodiment of the present invention, the step of forming the black pattern layer 408 includes forming the second electrode strips 402 on the second substrate 106 and forming the black shielding strips 406 on the second substrate 106. In the embodiment, the step of forming the second electrode strips 402 may be performed before or after the step of forming the black shielding strips 406. In another embodiment, the black pattern layer may also be formed on the outer surface of the second substrate or on the cover plate.

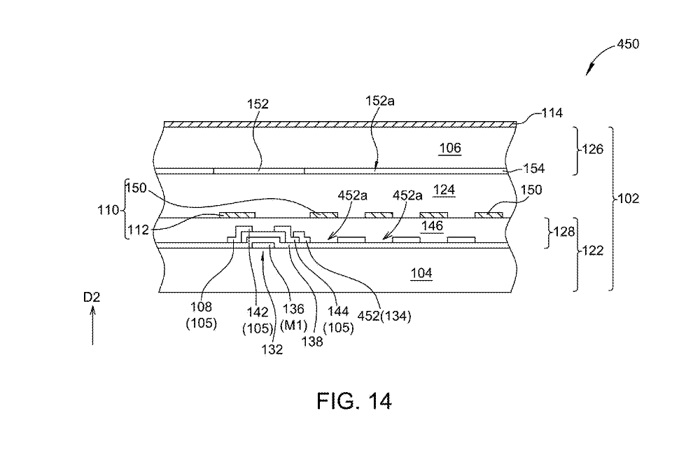

FIG. 14 shows a sixth embodiment of the present invention. Compared to the first embodiment, pixel electrodes 452 of a touch display device 450 of the embodiment include a plurality of narrow gaps 452a, which are disposed correspondingly to the third electrode strips 150, respectively.

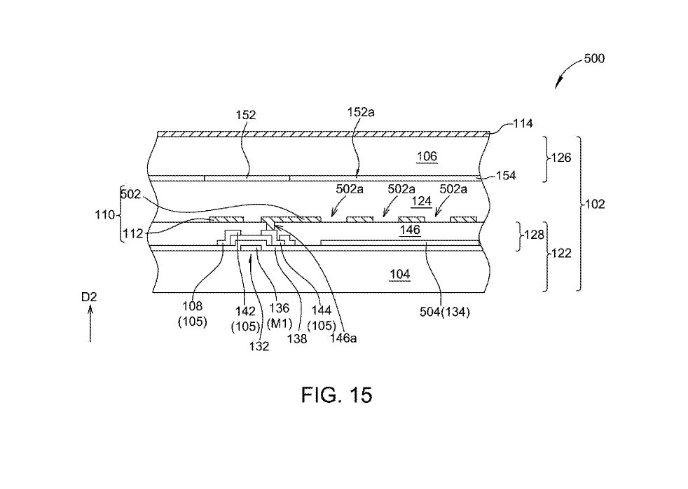

FIG. 15 shows a seventh embodiment of the present invention. Compared to the first embodiment, the first transparent layer 110 of a touch display device 500 of the embodiment includes a plurality of pixel electrodes 502 instead of including the third electrode strips. The pixel electrodes 502 include a plurality of narrow gaps 502a, and are insulated from one another. Thus, compared to the first embodiment, before the first transparent layer 110 is formed, the manufacturing method of the embodiment forms a plurality of through holes 146a in the insulation layer 146 to reveal the drains 144 of the second thin film transistors 132. As such, the pixel electrodes 502 subsequently formed are allowed to electrically connect to the drains 144 of the second thin film transistors 132 via the through holes 146a. Further, in the embodiment, the second transparent 134 formed before the insulation layer 146 is formed may include a common electrode pattern 504 disposed between the pixel electrodes 502 and the first substrate 104.

In conclusion, in the touch display device of the present invention, the metal lines may be utilized to transmit touch display signals including touch driving signals and pixel voltage signals or pixel switch signals. Thus, the metal lines not only can serve as conducting lines that the display panel uses to transmit the pixel voltage signals or the pixel switch signals, but also can respectively form touch electrode pairs with the second electrode strips by the coupled first electrode strips that are kept floating. It should be noted that, the first touch electrodes and the second touch electrodes of the present invention refer to a sequence of assigning the terms, and are not for limiting a stacking sequence of the electrodes on the display device or an operation sequence of the touch driving method, or electrode functions for transmitting touch signals or receiving sensing signals sensed. Accordingly, the touch electrode layer for transmitting touch signals can be omitted in the touch display device of the present invention to further effectively reduce the thickness and the manufacturing costs of the touch display device. Further, in the present invention, with the first electrode strips disposed between the metal lines and the second electrode strips, coupling capacitance between the metal lines and the second electrode strips can be increased, and the touch sensitivity of the touch sensing devices can also be enhanced.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch display device, comprising:
a first substrate;
a conductive layer, disposed above the first substrate, comprising a plurality of metal lines, the metal lines extending along a first direction and being insulated from one another;
a first transparent layer, disposed above the conductive layer, comprising a plurality of first electrode strips, the first electrode strips extending along the first direction and individually overlapping with one of the metal lines in a second direction substantially perpendicular to the first substrate; and
a plurality of second electrode strips, disposed above the first transparent layer, extending along a third direction;
wherein, the second electrode strips form capacitance coupling with the metal lines via the first electrode strips to perform touch sensing.

2. The touch display device according to claim 1, wherein each of the metal lines is a data line.

3. The touch display device according to claim 1, wherein each of the metal lines is a gate line.

4. The touch display device according to claim 1, wherein a width of each of the first electrode strip is greater than a width of each of the metal lines.

5. The touch display device according to claim 1, further comprising:
a second substrate, disposed opposite the first substrate;
wherein, the second electrode strips are disposed above an outer surface of the second substrate.

6. The touch display device according to claim 1, further comprising:
a second substrate, disposed opposite the first substrate;
wherein, the second electrode strips are disposed above an inner surface of the second substrate.

7. The touch display device according to claim 1, further comprising:
a second substrate, disposed opposite the first substrate; and
a cover plate, disposed above an outer surface of the second substrate;
wherein, the second electrode strips are disposed above a surface of the cover plate facing the second substrate.

8. The touch display device according to claim 1, further comprising:
a black pattern layer;
wherein, the second electrode strips are disposed in the black pattern layer.

9. The touch display device according to claim 1, further comprising:
a second transparent layer, disposed between the first transparent layer and the first substrate, the first transparent layer further comprising a plurality of third electrode strips, the second transparent layer comprising a plurality of pixel electrodes;
wherein, every two of the third electrode strips are disposed between any two adjacent first electrode strips.

10. The touch display device according to claim 1, further comprising:
a second transparent layer, disposed between the first transparent layer and the first substrate, the first transparent layer further comprising a plurality of pixel electrodes, the second transparent layer comprising a common electrode pattern disposed between the pixel electrodes and the first substrate;
wherein, the pixel electrodes have a plurality of narrow gaps.

11. The touch display device according to claim 1, wherein the first electrode strips are caused to receive a common voltage signal in a display period, the first electrodes are kept floating in a touch control period, and the display period and the touch control period are non-overlapping.

12. A driving method of a touch display device, the touch display device comprising a plurality of metal lines, a plurality of first electrode strips and a plurality of second electrode strips, the metal lines and the first electrode strips extending along a first direction, each of the first electrode strips individually overlapping with one of the metal lines in a second direction substantially perpendicular to the touch display device, the second electrode strips extending along a third direction, the driving method comprising:
in a display period, transmitting a display signal to one of the metal lines, and transmitting a common voltage signal to one of the first electrode strips; and
in a touch control period, transmitting a touch driving signal to the one of the metal lines, keeping the one of the first electrode strips corresponding to the one of the metal lines floating, and receiving a sensing signal from the second electrode strips corresponding to the one of the metal lines.

13. The driving method according to claim 12, wherein each of the metal lines is a data line.

14. The driving method according to claim 12, wherein each of the metal lines is a gate line.

15. A manufacturing method of a touch display device, comprising:
providing a first substrate;
forming a conductive layer above the first substrate, the conductive layer comprising a plurality of metal lines, the metal lines extending along a first direction and insulated from one another;
forming a first transparent layer above the conductive layer, the first transparent layer comprising a plurality of first electrode strips, the first electrode strips extending along the first direction and individually overlapping with one of the metal lines in a second direction substantially perpendicular to the first substrate; and
forming a plurality of second electrode strips above the first transparent layer, the second electrode strips extending along a third direction;
wherein, the second electrode strips form capacitance coupling with the metal lines via the first electrode strips to perform touch sensing.

16. The manufacturing method according to claim 15, further comprising:
providing a second substrate;
wherein, the second electrode strips are formed above an outer surface of the second substrate.

17. The manufacturing method according to claim 15, further comprising:
providing a second substrate;
wherein, the second electrode strips are formed above an inner surface of the second substrate.

18. The manufacturing method according to claim 15, further comprising:
providing a second substrate and a cover plate;
wherein, the second substrate is disposed between the cover plate and the first substrate, and the second electrode strips are formed above a surface of the cover plate facing the second substrate.

19. The manufacturing method according to claim 15, further comprising:
forming a black pattern layer;
wherein, the second electrode strips are disposed in the black pattern layer.

20. The manufacturing method according to claim 15, further comprising:
forming a second transparent layer between the first transparent layer and the first substrate;
wherein, the second transparent layer comprises a plurality of pixel electrodes, the first transparent layer further comprises a plurality of third electrode strips, and every two of the third electrode strips are disposed between any two adjacent first electrode strips.

21. The manufacturing method according to claim 15, further comprising:
forming a second transparent layer between the first transparent layer and the first substrate;
wherein, the second transparent layer comprises a common electrode pattern, the first transparent layer further comprises a plurality of pixel electrodes, each of the pixel electrodes has a plurality of narrow gaps, and the common electrode pattern is disposed between the pixel electrodes and the first substrate.
